(19) United States
(12) Patent Application Publication
(10) Pub. No.: US 2015/0360326 A1
(43) Pub. Date: Dec. 17, 2015

(54) METHOD TO ELIMINATE RECAST MATERIAL

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/302,492

(22) Filed: Jun. 12, 2014

(51) Int. Cl. B23K 35/22; B23K 7/08; B23K 10/00; C04B 41/53; C04B 41/00; B23K 15/08; B23K 26/38; C04B 41/91

(52) U.S. Cl. CPC B23K 35/228; B23K 26/381; B23K 7/08; C04B 41/91; C04B 41/5392; C04B 41/0054; C04B 41/0036; C04B 41/0027; B23K 15/085; B23K 10/00

(57) ABSTRACT

A method to remove material from a substrate (10) without producing problematically adhering recast material. Material is removed from the substrate with an energy beam (14) in the presence of a flux material (12). The flux material is reactive with the ablated substrate material to form a recast slag material (18). The recast slag material exhibits mechanical properties making it easy to remove from the substrate. The flux material composition is selected in consideration of the composition of the substrate, for example to reduce the formation of any problematic compounds that promote adhesion, such as spinels and perovskites, or to have a different coefficient of thermal expansion than the substrate.

### FIELD OF THE INVENTION

This invention relates generally to the field of materials technology, and more particularly to high temperature material removal processes such as laser machining.

### BACKGROUND OF THE INVENTION

Many types of material removal processes are known in the art; for example, mechanical processes such as drilling, sawing, grinding, etc. and thermal processes such as oxy-fuel cutting, electrical discharge machining (EDM), laser cutting, etc. One disadvantage of thermal processes is the re-solidification and deposition of vaporized and/or molten material proximate the area of material removal. The deposited material is generally known as recast material. Recast material can cause the edge of a cut to be geometrically inconsistent and to have an undesired rough surface finish. Recast material has been known to partially block cooling holes formed by laser drilling in gas turbine components. Moreover, recast material can contain cracks formed as a result of the configuration and/or rapid solidification of the material, and such cracks may grow into the underlying substrate material during subsequent operation of the component, thereby limiting component life. Accordingly, it is common to remove recast material by a further mechanical, thermal or chemical process, but such processes add time and expense to a manufacturing operation, and they may be incomplete or they may cause the undesired removal of material other than recast material.

### BRIEF DESCRIPTION OF THE DRAWINGS

The invention is explained in the following description in view of the drawings that show:

FIG. 1 schematically illustrates a substrate covered with a flux material about to undergo a laser drilling operation.

FIG. 2 illustrates the substrate of FIG. 1 upon completion of the laser drilling and showing recast slag material deposited around the drilled hole.

FIG. 3 illustrates the recast slag material of FIG. 2 having been removed from the substrate by a mechanical process.

### DETAILED DESCRIPTION OF THE INVENTION

The present inventors have developed a technique for handling recast material formed during thermal material removal processes. The technique generally utilizes a flux material to react with the thermally displaced material to resolve it into a friable, easily removable recast slag.

The term “friable” is used herein when referring to a recast slag material to mean that the material can be broken apart and easily detached from a surface to which it is adhering by mechanical impact such as with a hammer, file or other tool, or by blasting such as with glass beads. Fluxes that create detachable slags are known for conventional welding processes; however, to the knowledge of the present inventors, fluxes have not been contemplated for material removal processes for the purpose of eliminating recast material. This application teaches such concept.

Thermal material removal methods that create recast material may utilize a variety of heat sources. The terms “energy beam” and “beam energy” are used broadly herein to describe such heat sources collectively, and they are meant to include laser beams, ion beams, electron beams, plasma beams, and superheated gas streams such as produced by an oxy-fuel cutting torch.

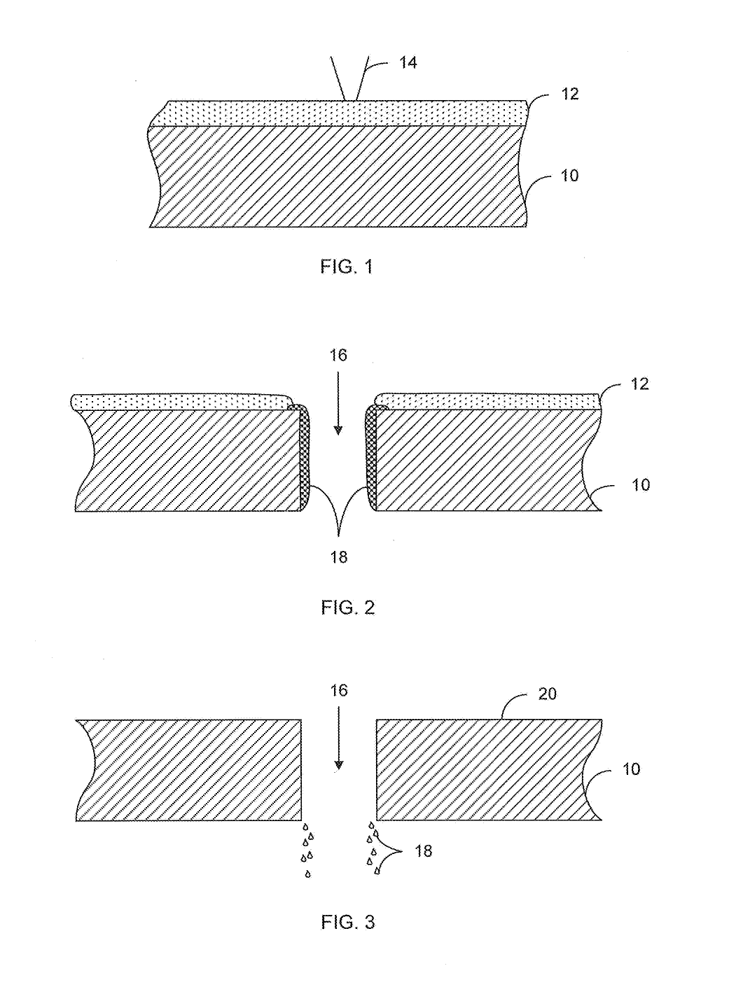

FIGS. 1-3 schematically illustrate steps in a method according to an embodiment of the invention. In FIG. 1, a solid substrate material 10 is covered by a layer of flux material 12 proximate a planned material removal location, such as the location of a cooling hole in a gas turbine engine component. An energy beam, such as laser beam 14, has been directed toward the flux covered substrate, although no ablation of material is illustrated in this figure. While FIG. 1 illustrates a pre-placed layer of flux material 12 which may cover an area where more than one material removal operation is planned, such as a series of side-by-side cooling holes, it will be appreciated that the flux material may alternatively be delivered to the material removal location coincident with the energy beam. Coincident heat/flux application may be particularly useful when the material removal is intended to produce a deep and/or narrow cut or hole.

FIG. 2 illustrates substrate 10 upon completion of the thermal material removal step wherein a hole 16 has been formed as a result of the laser-induced melting and vaporization of solid material from the substrate 10. A layer of recast slag material 18 has been deposited proximate the material removal location including within, above and around the hole 16. The recast slag material 18 is formed by the reaction of the molten and/or vaporized substrate material with the flux material 12 and surrounding atmosphere and process gas (if any), and it is composed, at least in part, of material(s) that are brittle and friable.

FIG. 3 illustrates the substrate 10 after excess unmelted flux has been removed and the hole 16 has been cleaned by mechanically removing the recast slag material 18, such as by tapping a clearance tool into the hole 16 and/or by scraping a chisel along the surface 20 of the substrate 10. Note that the recast slag material 18 is illustrated as being broken into multiple smaller pieces by the removal process, as commonly happens when friable slag is removed after a welding process.

The flux material 12 is chosen in view of the material of the substrate 10 such that a high temperature reaction of the two materials produces a recast composition that exhibits properties making it easy to remove from the substrate 10. For example, the recast slag material 18 may be brittle and may have a different coefficient of thermal expansion than the substrate 10, resulting in the build-up of stresses there between upon solidification and cooling of the assembly. In some embodiments the recast slag material 18 and substrate 10 may have a high differential coefficient of thermal expansion. For example, it is known that from 1,000° C. to room temperature, typical substrate and deposited iron and nickel alloys have linear thermal contraction values of the order of 0.014 mm/mm. Corresponding welding slags over such alloys can have values of the order of 0.004 mm/mm. Such a large differential can be useful in detaching such slag from the substrate, and such slag may even be self-removing due to the developed thermal stresses generated as the recast slag 18 cools and solidifies. Embodiments of the invention select the flux material such that the ratio of the thermal contraction value of the substrate to the thermal contraction value of the recast slag is at least two or at least three from 1,000° C. to room temperature. The recast slag material 18 will also have a different crystal structure and chemical makeup than the substrate 10, thereby minimizing chemical bonding there between.

Many stainless steels and nickel based superalloys contain significant amounts of chromium. Thermal removal of such materials in the presence of oxygen will produce a recast material containing oxides of chrome. Such recast material is known to be tenacious and difficult to remove from the underlying stainless steel or superalloy substrate because of the formation of spinels (e.g. MgAlCrO₄) that embed in the metal deposit and anchor and lock the recast material in place. A similar problem occurs when thermally removing material from a titanium bearing substrate due to the formation of perovskites. Embodiments of the invention may provide a material in the flux material 12 that reduces the formation of such problematic compounds. This may be accomplished by selecting the flux material 12 to contain a material which will form an oxide having a lower Gibbs free energy change than a known problematic compound, such as spinels or perovskites. If two metals are present, two equilibriums must be be considered. The oxide with the more negative Gibbs free energy change (delta G) will be formed and the other oxide will be reduced. For example, by including aluminum (or alumina) in the flux material 12, oxides of chrome can be reduced when compared to a prior art process without the flux. Removal or reduction of a problematic compound in the recast slag material 18 will facilitate its removal from the underlying substrate 10.

An exemplary embodiment useful for thermal material removal from an aluminum substrate 10 may include zirconium in the flux material 12. When aluminum is melted and vaporized in a prior art material removal process, the recast material is formed as alumina (Al₂O₃) which will bond tightly to the aluminum substrate 10. By performing a thermal material removal process of aluminum under a covering flux containing zirconium, the melted zirconium will scavenge oxygen from the region of material removal and will form a recast slag material 18 containing a relatively larger quantity of zirconia and a relatively smaller quantity of alumina. This composition of recast slag material 18 will not adhere well to the aluminum substrate 10 due to its different coefficient of thermal expansion (10.3/° C. for zirconia versus 24/° C. for aluminum) as well as its different crystal structure(monoclinic for zirconia versus face centered cubic for aluminum).

Carbon may be useful in the flux material 12 for some applications. Coke is widely used in steelmaking for oxide reduction. The Ellingham curve for the reaction 2C(s)+O₂(g)>2CO(g) slopes downward and falls below the curves for all of the metals. Hence, carbon can normally act as a reducing agent for all metal oxides at very high temperatures. Note that carbon may not be desired to reduce chromium oxides because it will form unwanted chromium carbides.

Table 1 identifies materials that are often thermally removed and the resultant forms of recast material, along with flux compounds that may be useful to resolve those recast materials into a fugitive slag compound.

TABLE 1

| MATERIAL | ASSIST GAS | RECAST MATERIAL | FLUX TO RESOLVE |
|---|---|---|---|
| carbon steel | oxygen | iron oxide | Al, Ti, Cr, Zr, Mg, C |
| alloy steel | oxygen | iron and chromium | Al, Ti, Zr, Mg oxides, |
| | | oxides | fluoride, C |
| stainless steel | oxygen | chromium oxide | Al, Ti, Zr, fluoride |
| | nitrogen | nitrides and oxides | Al, Ti oxides |
| | | (entrained air) | |
| | helium, argon | nitrides and oxides | Al, Ti, Zr, fluoride |
| | | (entrained air) | |
| nickel alloy | oxygen | chromium and nickel | Al, Ti, Zr, fluoride |
| | | oxides | |
| | nitrogen | nitrides and oxides | Al, Ti oxides |
| | | (entrained air) | |
| | helium, argon | nitrides and oxides | Al, Ti, Zr, fluoride |
| | | (entrained air) | |
| aluminum | oxygen | alumina | Zr, zircon sand |
| | | | (zirconium silicate) |
| non-metals | oxygen | various oxides and | Al, Ti, Cr, Zr, Mg |
| | | nitrides | oxides, fluoride |

Fluxes useful in embodiments of the present invention will likely contain little or no calcium fluoride because of its deleterious effect on detachability due to cuspidine formation and the interaction with silica. Alternative fluorides may be utilized for slag fluidity control.

Process parameter controls in conjunction with the invention include power, travel speed, pulse controls and flux thickness, such as may result in high differential thermal contraction and relatively slow cooling rates to optimize slag detachability.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A material removal method comprising:
applying beam energy to a solid substrate in a manner effective to remove material from the substrate at a material removal location and to deposit recast material onto the substrate proximate the material removal location;
providing a flux material proximate the material removal location during the step of applying beam energy, the flux material selected to react with the removed material to form the recast material as a recast slag material; and
removing the recast slag material from the substrate.

2. The method of claim 1, further comprising:
identifying a problematic oxide formed in the recast material that contributes to adhesion of the recast material to the substrate; and
selecting the flux material to comprise a constituent forming an oxide in the recast slag material having a lower Gibbs free energy change than the problematic oxide.

3. The method of claim 2, wherein the substrate comprises chromium and the problematic oxide comprises a spinel, further comprising selecting the flux material to comprise aluminum or alumina.

4. The method of claim 1, wherein the substrate material comprises a carbon steel and the flux material comprises at least one of the group of aluminum, titanium, chromium, zirconium, magnesium and carbon.

5. The method of claim 1, wherein the substrate material comprises an alloy steel and the flux material comprises at least one of the group of aluminum, titanium, zirconium, a magnesium oxide, a fluoride and carbon.

6. The method of claim 1, wherein the substrate material comprises a stainless steel and the flux material comprises at least one of aluminum, titanium, zirconium and a fluoride.

7. The method of claim 1, wherein the substrate material comprises a nickel based alloy and the flux material comprises at least one of the group of aluminum, titanium, zirconium and a fluoride.

8. The method of claim 1, wherein the substrate material comprises aluminum and the flux material comprises at least one of the group of zirconium and zircon sand.

9. The method of claim 1, wherein the substrate material comprises a non-metal and the flux material comprises at least one of the group of aluminum, titanium, chromium, zirconium, and a magnesium oxide.

10. The method of claim 1, further comprising selecting the flux material to comprise at least one of the group consisting of aluminum, titanium, zirconium, carbon and a fluoride.

11. The method of claim 1, further comprising selecting the flux material such that a ratio of a thermal contraction value of the substrate to a thermal contraction value of the recast slag is at least two.

12. The method of claim 1, further comprising selecting the flux material such that a ratio of a thermal contraction value of the substrate to a thermal contraction value of the recast slag is at least three.

13. A material removal method comprising:
applying heat to remove material from a solid substrate; and
providing a flux material during the step of applying heat, the flux material selected to react with removed material to form a friable recast slag material on the substrate.

14. The method of claim 13, further comprising selecting the flux material to comprise a constituent forming an oxide in the recast slag material having a lower Gibbs free energy change than an oxide that would otherwise be formed in the recast material formed in the absence of the flux material.

15. The method of claim 13, further comprising selecting the flux material such that a ratio of a thermal contraction value of the substrate to a thermal contraction value of the recast slag is at least two.

16. The method of claim 13, wherein the substrate material comprises a stainless steel or a nickel based alloy and the flux material comprises at least one of aluminum, titanium, zirconium and a fluoride.

17. A material removal method wherein an energy beam is used to form an opening in a solid substrate and wherein removed material is re-solidified proximate the opening as recast material, the material removal method characterized by providing a flux material effective to react with the removed material to form the recast material as a friable slag material.

18. The method of claim 17, further comprising providing the flux material effective to form the recast material to have a coefficient of thermal expansion of less than half a coefficient of thermal expansion of the substrate under the same conditions.
